(19) United States
(12) Patent Application Publication
(10) Pub. No.: US 2020/0009761 A1
(43) Pub. Date: Jan. 9, 2020

(54) SELF-CONTAINED PORTABLE TILE CUTTING SYSTEM

(71) Applicant: Richard Dale Parker, Apopka, FL (US)

(72) Inventor: Richard Dale Parker, Apopka, FL (US)

(21) Appl. No.: 16/028,023

(22) Filed: Jul. 5, 2018

(51) Int. Cl. B28D 1/22; B28D 1/24

(52) U.S. Cl. CPC B28D 1/225; B28D 1/24

(57) ABSTRACT

An angle grinder attachment which creates a portable, cordless, dustless, indoor ceramic tile cutting machine. There is no dust produced when using this attachment. The dust (and silica) are turned into a paste which is easily cleaned and disposed of. This attachment does not require electricity or running water in the field. This attachment is truly portable, it is self-contained, and it can be used indoors without creating dust or flooding an area with water

### BACKGROUND OF THE INVENTION

The present invention relates to cutting tools, and more particularly to cutting tools for ceramics, stone, and like materials.

Cutting ceramic tile, porcelain, marble, granite, or cultured marble with an angle grinder produces unacceptable levels of dust and silica. The AC electric water-fed models in the art require electricity, and they need a significant amount of water to operate (which cannot be used indoors without a basin or reservoir to catch the water).

In some instances, vacuum tile cutters are known that are intended to suction the released particulates. However, the AC electric vacuum models do not provide the dust/silica containment in accordance with the new OSHA silica standards, and they also require electricity. The vacuum models do not contain the silica dust well enough when cutting, because the blade is partially above the item being cut, and partially below due to the design of an angle grinder. They also require a large electric vacuum, and filters/bags that need constant servicing.

They both AC and vacuum models require a running water supply and/or AC electricity, which are not always available in the field. The water attachment for the AC electric model uses so much water it would flood a room in a short amount of time. The current water models on the market are meant for a shop environment.

As can be seen, there is a need for an apparatus and method for containment of particulate matter while cutting tile.

### SUMMARY OF THE INVENTION

In one aspect of the present invention an tile cutting shroud for an angle grinder, is disclosed. The tile cutting shroud includes an arcuate shroud configured to be operatively coupled to the angle grinder about a rotational axis of the angle grinder. The arcuate shroud at least partially encloses an interior exterior face of a tile cutting blade attached to the angle grinder and extends beyond a cutting axis of the tile cutting blade. A containment plate is formed as a segment of a circular arc defined by a chord extending across the arcuate shroud beginning at a forward end of the shroud and terminates at a point proximal to the rearward radius of the tile cutting blade. A fluid supply hole is defined through an aft end of the containment plate, the hole having a diameter to receive a fluid mist line; wherein the fluid mister line is longitudinally disposed against an interior surface of the containment plate. The fluid mister line has a plurality of spaced apart apertures oriented towards a cutting edge of the cutting blade, wherein the fluid mister line is adapted to receive a pressurized source of fluid.

The plurality of spaced apart apertures are dimensioned to produce a mist of the pressurized fluid to entrap particulates produced when the tile cutting blade cuts a section of tile. A plurality of holes may be defined in the containment plate along a longitudinal length of the fluid supply line. A fastener is received in each of the plurality of holes to secure the fluid mister line against the interior surface of the containment plate. The fastener may be a tie-wrap wherein a head of the tie-wrap is positioned on an exterior side of the hole and a loop of the tie-wrap strap encircles the fluid mister line.

In some embodiments, the tile cutting shroud may also include a fluid shutoff valve. The fluid shutoff valve is adapted to be mounted to a back surface of the angle grinder, the fluid shutoff valve adapted to interconnect the fluid mister line with a portable fluid reservoir.

In other aspects of the invention, a self-contained tile cutting apparatus is disclosed. The tile cutting apparatus includes a battery operated rotary angle grinder having a tile cutting blade attached to a output shaft of the battery operated rotary angle grinder. An arcuate shroud is attached to the angle grinder about a rotational axis of the angle grinder. The arcuate shroud at least partially encloses an interior face of the tile cutting blade and extends beyond a cutting axis of the tile cutting blade. A containment plate formed as a segment of a circular arc defined by a chord extending across the arcuate shroud beginning at a forward end of the shroud and terminating at a point proximal to the rearward radius of the tile cutting blade. The containment plate partially covers an exterior face of the tile cutting blade. A fluid supply hole is defined through an aft end of the containment plate, the hole having a diameter to receive a fluid mister line. A fluid supply line is in communication with the fluid mister line and a portable water delivery reservoir.

In some embodiments, a shutoff valve is attached to the angle grinder. The shutoff valve is interposed between the fluid mister line and the fluid supply line. The shutoff valve is operable between an open fluid communication position and a closed fluid blocking position.

A plurality of holes may be defined in the containment plate along a longitudinal length of the fluid supply line. A fastener is received in each of the plurality of holes to secure the fluid mister line against the interior surface of containment plate. The fastener may be a tie-wrap, wherein a head of the tie-wrap is positioned on an exterior side of the hole and a loop of the tie-wrap strap encircles the fluid mister line.

In yet other embodiments, the self-contained tile cutting apparatus includes a hand pump attached to the portable water delivery reservoir, wherein the hand pump is operable to pressurize a quantity of water carried in the portable water delivery reservoir and communicate the water to the fluid mister line.

These and other features, aspects and advantages of the present invention will become better understood with reference to the following drawings, description and claims.

### BRIEF DESCRIPTION OF THE DRAWINGS

FIG. 1 is a perspective view of an embodiment a self-contained portable tile cutting system.

FIG. 2 is a bottom perspective view of a tile cutting shroud applied to an angle grinder.

FIG. 3 is a side perspective view of the tile cutting shroud applied to the angle grinder.

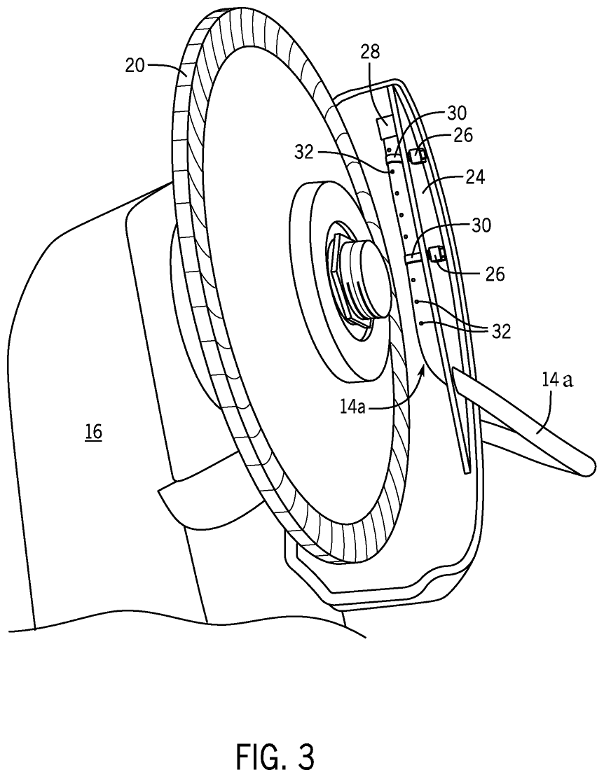

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

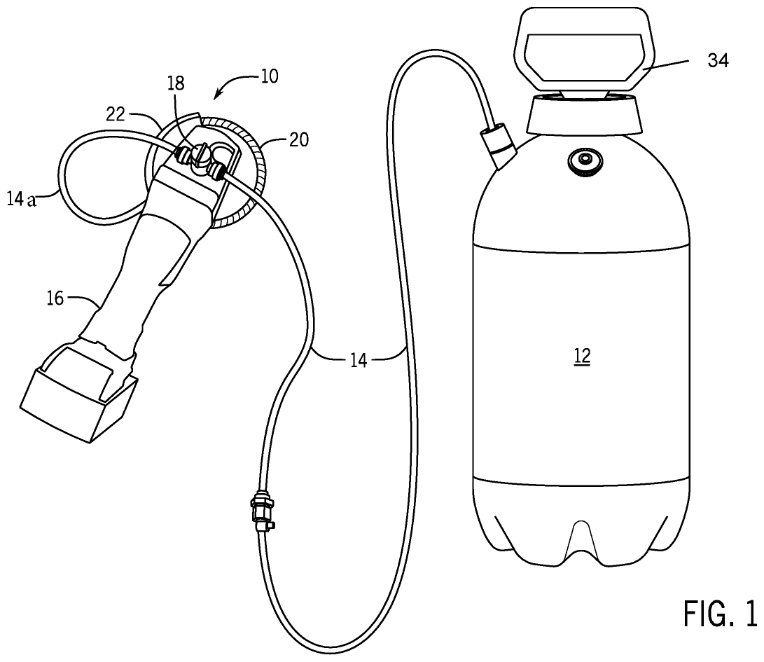

Broadly, embodiments of the present invention provide a self-contained system, method, and apparatus for cutting tile without access to utilities, such as water and electric power. As seem in reference to FIG. 1, a self-contained portable tile cutting system 10 according to aspects of the invention includes a portable water delivery reservoir 12, a fluid supply line 14 in communication with an battery operated rotary angle grinder 16, a fluid control valve 18, a tile cutting blade 20; and an arcuate water containment shroud 22 partially enclosing a portion of the tile cutting blade 20.

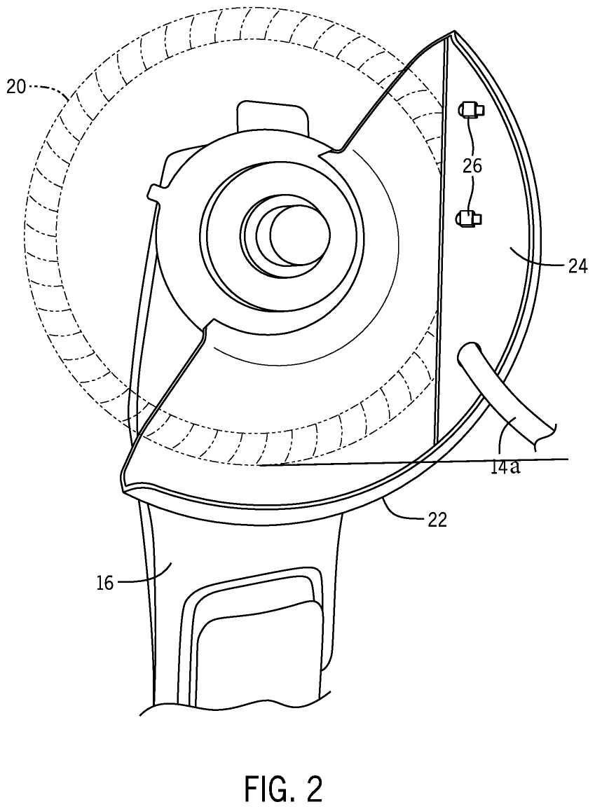

As seen in the detail view of the angle grinder 16 attachment 22, shown in reference to FIG. 2, the arcuate shroud 22 is operatively coupled to the angle grinder 16 about a rotational axis of the grinder 15 so that the arcuate shroud 22 partially encloses an interior and extends beyond a cutting axis of the tile cutting blade 20. The arcuate shroud 22 has a containment plate 24 formed as a segment of a circular arc defined by a chord extending across a top end of the cutting blade 20. The chord may begin at a forward end of the shroud 22 and terminate at a point proximal to the rearward radius of the tile cutting blade 20.

A hole is defined through an aft end of the containment plate 24 having a diameter to receive the fluid mister line 14a. The fluid mister line 14 is longitudinally disposed against an interior surface of the containment plate 24 and is secured by a plurality of fasteners 26, such as tie wraps, or clips extending through securement holes in a side of the containment plate 24. A cap 28 or plug is applied to a terminal end of the fluid mister line 14a and a strap portion of the plurality of fasteners 26 encircles the fluid mister line 14a.

A plurality of spaced apart apertures 32 are defined along a longitudinal length of the fluid mister line 14a and oriented towards a cutting axis of the tile cutting blade 20. The plurality of spaced apart apertures 32 are defined to direct a fine mist of liquid within the shroud 22 to entrap particulates released by engagement of the cutting blade 20 with the tile during cutting. The fluid mister line 14 between the shutoff valve 18 and its termination at the end cap 28 may be formed of a flexible rubber or a rigid plastic or metallic material.

In operation, the portable water delivery reservoir 12 is filled with fresh water, and a hand pump 34 is pumped several times to pressurize water contained the reservoir 12. The switch on the angle grinder is squeezed which activates the grinder motor and brings the tile cutting blade 20 up to operating rpm. The water shut-off valve 18 can then be opened to allow the desired amount of water to be fed to the blade 20, via the plurality of apertures 32. The cut can then be performed on the item needing trimmed without creating any dust. When the cut is finished, the water shut-off valve 18 can be closed which will stop the water being fed to the tile cutting blade 20. The lever on the grinder can be simultaneously released which will stop the motor and blade 20 from turning.

Aspects of the present invention may be applied to a rechargeable battery operated angle grinder 16 as a complete shroud kit, or as an adaptation kit for an existing angle grinder shroud 22. This invention is an improvement on what currently exists. There are no similar devices available at this time. This invention is portable, and it does not require electricity, running water, vacuums, or vacuum bags/filters.

It should be understood, of course, that the foregoing relates to exemplary embodiments of the invention and that modifications may be made without departing from the spirit and scope of the invention as set forth in the following claims.

What is claimed is:

1. A tile cutting shroud for an angle grinder, comprising:
an arcuate shroud configured to be operatively coupled to the angle grinder about a rotational axis of the angle grinder, the arcuate shroud at least partially encloses an interior exterior face of a cutting blade attached to the angle grinder and extends beyond a cutting axis of the tile cutting blade,
a containment plate formed as a segment of a circular arc defined by a chord extending across the arcuate shroud beginning at a forward end of the shroud and terminating at a point proximal to the rearward radius of the tile cutting blade,
a fluid supply hole defined through an aft end of the containment plate, the hole having a diameter to receive a fluid mist line; wherein the fluid mister line is longitudinally disposed against an interior surface of the containment plate, the fluid mister line having a plurality of spaced apart apertures oriented towards a cutting edge of the cutting blade, wherein the fluid mister line is adapted to receive a pressurized source of fluid.

2. The tile cutting shroud of claim 1, wherein the plurality of spaced apart apertures are dimensioned to produce a mist of the pressurized fluid to entrap particulates produced when the tile cutting blade cuts a section of tile.

3. The tile cutting shroud of claim 2, further comprising:
a plurality of holes defined in the containment plate along a longitudinal length of the fluid supply line; and
a fastener received in each of the plurality of holes to secure the fluid mister line against the interior surface of containment plate.

4. The tile cutting shroud of claim 3, wherein the fastener is a tie-wrap wherein a head of the tie-wrap is positioned on an exterior side of the hole and a loop of the tie-wrap strap encircles the fluid mister line.

5. The tile cutting shroud of claim 3, further comprising:
a fluid shutoff valve, adapted to be mounted to a back surface of the angle grinder, the fluid shutoff valve adapted to interconnect the fluid mister line with a portable fluid reservoir.

6. A self contained tile cutting apparatus, comprising:
a battery operated rotary angle grinder having a tile cutting blade attached to a output shaft of the battery operated rotary angle grinder
an arcuate shroud attached to the angle grinder about a rotational axis of the angle grinder, the arcuate shroud at least partially enclosing an interior face of the tile cutting blade and extending beyond a cutting axis of the tile cutting blade,
a containment plate formed as a segment of a circular arc defined by a chord extending across the arcuate shroud beginning at a forward end of the shroud and terminating at a point proximal to the rearward radius of the tile cutting blade, the containment plate partially covering an exterior face of the tile cutting blade
a fluid supply hole defined through an aft end of the containment plate, the hole having a diameter to receive a fluid mister line,
a fluid supply line in communication with the fluid mister line and a portable water delivery reservoir.

7. The self contained tile cutting apparatus of claim 6, further comprising:
a shutoff valve attached to the angle grinder, the shutoff valve interposed between the fluid mister line and the fluid supply line, wherein the shutoff valve is operable between an open fluid communication position and a closed fluid blocking position.

8. The self contained tile cutting apparatus of claim 7, further comprising:
a plurality of holes defined in the containment plate along a longitudinal length of the fluid supply line; and
a fastener received in each of the plurality of holes to secure the fluid mister line against the interior surface of containment plate.

9. The self contained tile cutting apparatus of claim 8, the fastener comprising:
a tie-wrap wherein a head of the tie-wrap is positioned on an exterior side of the hole and a loop of the tie-wrap strap encircles the fluid mister line.

10. The self contained tile cutting apparatus of claim 6, further comprising:
a hand pump attached to the portable water delivery reservoir, wherein the hand pump is operable to pressurize a quantity of water carried in the portable water delivery reservoir and communicate the water to the fluid mister line.
